(19) United States
(12) Patent Application Publication
(10) Pub. No.: US 2026/0244160 A1
(43) Pub. Date: Aug. 20, 2026

(54) WATCH GLASS

(71) Applicant: Smiling Rocks IP, Inc., New York, NY (US)

(72) Inventor: Sureshkumar Ghevriya, New York, NY (US)

(21) Appl. No.: 19/057,698

(22) Filed: Feb. 19, 2025

(51) Int. Cl. G04B 39/00; G02B 1/14

(52) U.S. Cl. CPC G04B 39/006; G02B 1/14

(57) ABSTRACT

A watch glass is provided. The watch glass is defined by a first and second surface spaced apart from each other by a thickness therebetween and a circumferential edge that defines a side surface of the first and second surfaces and the thickness. The thickness of the watch glass is made from a diamond material. This allows the watch glass to be harder than conventional watch glass materials and more luxurious than ordinary watch glasses.

### BACKGROUND

The present inventions relate generally to clear materials that may be visually seen through, and more particularly, to a watch glass for covering a watch face.

A conventional watch glass is used to cover and protect the face of a watch. Since the user must be able to see the watch face underneath a watch glass in order to tell the time, the watch glass must be transparent. Further, since watches are typically worn by users on their wrist, it is common for the outer surface of a watch glass to come into contact with various objects during normal use. Thus, one purpose of a watch glass is to protect the watch face from damage.

Traditionally, watch glasses have been made out of sapphire. However, sapphire watch glasses are not as hard as other materials and are prone to being scratched with repeated use. Additionally, some watches are designed as luxury items which preferably utilize luxury materials. Thus, there may be a desire for premium watch glasses that perform better than traditional watch glasses and are made from more valuable materials.

### SUMMARY

A watch glass is described having a thickness between outer and inner surfaces and within a circumferential edge. The thickness of the watch glass is made from a diamond material. Preferably, the diamond material is a lab grown diamond material. This allows the watch glass to be more resistant to scratches since the diamond material is harder than conventional materials used in watch glasses. Additionally, the watch glass may make a watch more desirable to luxury buyers since diamond is considered to be a luxury material. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawing, in which:

FIG. 1 illustrates a watch; and

FIG. 2 illustrates a watch glass.

### DETAILED DESCRIPTION

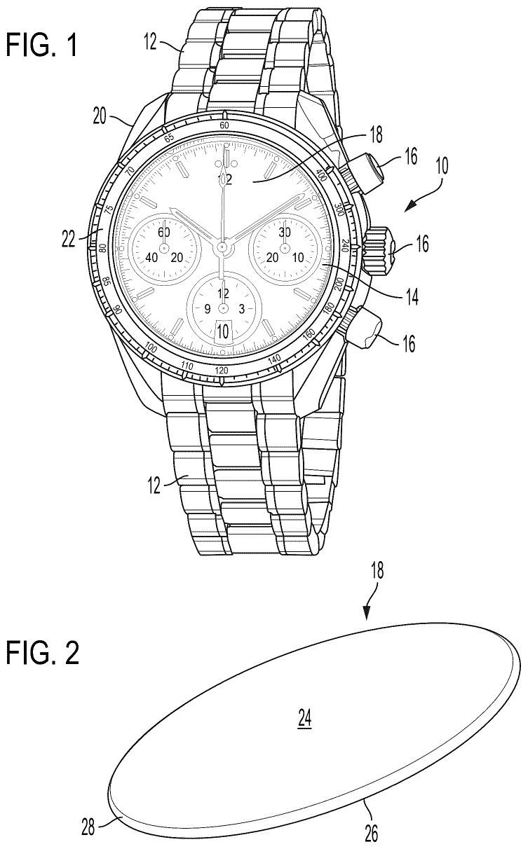

Referring now to the figures, and particularly to FIG. 1, a watch 10 is shown. The watch 10 is mostly conventional in nature in that it may have a watchband 12, a watch face 14, and buttons or dials 16. The watchband 12, or other strap, is used to wear the watch 10 around the user's wrist. It is understood that a strap may also be used to connect a watch to a piece of the user's clothing. The watch face 14 is used by the user to tell the time. It is understood that watches 10 may have an analog watch face 14 with arms as shown or may have a digital watch face with numbers illustrating the time. The buttons or dials 16 may be used by the user to adjust the time or make other adjustments to the settings of the watch 10.

Referring to FIGS. 1-2, the watch 10 also has a watch glass 18. The watch glass 18 covers the watch face 14 in order to protect the watch face 14 from coming into contact with the surrounding environment as the user wear's the watch 10 during normal activity. The watch glass 18 may be retained in place by being squeezed between the main body 20 of the watch 10 and a bezel 22 on top of the upper edge of the watch glass 18.

Because the user must be able to see the watch face 14 under the watch glass 18 in order to tell the time, the watch face 14 is preferably as transparent as possible. Thus, in FIG. 1 it is not readily apparent that a watch glass 18 is covering the watch face 14, but a watch glass 18 like the one shown in FIG. 2 is mounted on the main body 20 of the watch 10 over the watch face 14. The watch glass 18 may have a first surface 24 (e.g., outer surface 24) and a second surface 26 (e.g., inner surface 26) which are spaced apart from each other by the thickness of the watch glass 18. The circumferential edge 28 of the watch glass 18 defines the side surface of the watch glass 18 including the first and second surfaces 24, 26 and the thickness of the watch glass 18.

In a preferred embodiment, the circumferential edge 28 of the watch glass 18 is circular. Preferably, the watch glass 18 has a circumferential edge 28 that is between a diameter of 5 to 50 mm (it is understood herein that the cited ranges include the terminal values of the range). More preferably, the circumferential edge 28 is between 38 to 42 mm. The watch glass 18 also preferably has a thickness that is between 1 to 7 mm. More preferably, the thicknesses is between 1 to 2 millimeters.

Unlike conventional watch glasses 18, the watch glass 18 described herein is made from diamond. That is, the thickness of the watch glass 18 between the first and second surfaces 24, 26 and within the circumferential edge 28 is made from diamond. Because diamond is harder than any other materials used for watch glasses, the described diamond watch glass 18 is more resistant to scratches than conventional watch glasses. That means that the watch glass 18 can be used on a watch 10 longer than conventional watch glasses before needing to be replaced due to annoying scratches. Additionally, because diamond is considered to be a luxury material, it may be desirable to use the watch glass 18 on more expensive luxury watches 10 in order to make such watches 10 even higher quality luxury goods.

Even more preferably, the watch glass 18 is made from lab grown diamond. This allows the diamond material to be formed in the shape of a watch glass 18 in a more economical and practical way than if ordinary mined diamonds were used. It should be noted that the diamond material as described herein could also be used for eyeglass lenses or for smart phone protective glass covers. The diamond of the watch glass 18 may be polycrystalline, which means that multiple diamond crystals are formed next to each other with the diamond crystals growing into each other to form a full watch glass 18. On the other hand, the diamond of the watch glass 18 may more preferably be monocrystalline, which means that the full watch glass 18 is made of a single diamond crystal. Monocrystalline diamond may be more preferred since polycrystalline diamond material may have minute seams between the multiple diamond crystals.

Known methods may be used to grow the diamond material for the watch glass 18 in a lab. For instance, HPHT (high-pressure, high-temperature) and CVD (chemical vapor deposition) methods may be used to make the diamond material. In the HPHT process, one or more diamond seeds are placed within a press along with carbon, such as graphite. Other materials, such as iron, nickel and/or cobalt may also be placed in the press to lower the temperature and pressure needed to grow diamond material. The material in the press is then heated (e.g., 1,300-1,600° C.) and pressurized (e.g., above 870 ksi), which causes carbon atoms to precipitate on the diamond seed(s) to thereby grow additional diamond material on the seed(s). In the CVD process a vacuum chamber is used instead. Like HPHT, one or more diamond seeds are placed within the chamber. The chamber is also filled with a carbon-containing gas. The chamber is then heated (e.g., 900-1,200° C.), and a microwave beam is applied to the chamber. This causes carbon atoms to precipitate out of the gas onto the diamond seed(s) to thereby grow additional diamond material on the seed(s). It is understood, however, that these are only examples of how diamond material may be grown in a lab, and any method of growing diamond material in a lab may be used to make the described watch glass 18.

The diamond material is preferably grown in a shape that is only marginally larger than the finished shape of the watch glass 18. For example, the thickness of the lab grown diamond material may be less than twice the thickness of the final watch glass 18, and more preferably, less than 50% greater than the final watch glass 18 thickness. Likewise, the circumference of the lab grown diamond material may be less than 30% greater than the final watch glass 18, and more preferably, less than 10% greater than the final watch glass 18 thickness. After the lab grown diamond material has been made, it is then cut and polished (e.g., the first and second surfaces 24, 26 and the circumferential edge 28) to form the finished watch glass 18.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A watch glass, comprising:
a first surface and a second surface spaced apart by a thickness therebetween;
a circumferential edge defining a side surface of the first and second surfaces and the thickness;
wherein the thickness between the first and second surfaces and within the circumferential edge is made from diamond.

2. The watch glass according to claim 1, wherein the diamond is a lab grown diamond.

3. The watch glass according to claim 2, wherein the diamond is polycrystalline.

4. The watch glass according to claim 2, wherein the diamond is monocrystalline.

5. The watch glass according to claim 1, wherein the circumferential edge is circular.

6. The watch glass according to claim 1, wherein the circumferential edge is between a diameter of 5 to 50 mm.

7. The watch glass according to claim 6, wherein the circumferential edge is between a diameter of 38 to 42 mm.

8. The watch glass according to claim 1, wherein the thickness is between 1 to 7 mm.

9. The watch glass according to claim 8, wherein the thickness is between 1 to 2 mm.

10. The watch glass according to claim 1, wherein the diamond is transparent such that a watch face disposed under the watch glass is visible through the thickness.

11. The watch glass according to claim 10, wherein the diamond is a lab grown diamond.

12. The watch glass according to claim 11, wherein the circumferential edge is circular.

13. The watch glass according to claim 12, wherein the circumferential edge is between a diameter of 5 to 50 mm.

14. The watch glass according to claim 13, wherein the thickness is between a diameter of 1 to 7 mm.

15. The watch glass according to claim 14, wherein the circumferential edge is between a diameter of 38 to 42 mm.

16. The watch glass according to claim 15, wherein the thickness is between a diameter of 1 to 2 mm.

17. The watch glass according to claim 16, wherein the diamond is polycrystalline.

18. The watch glass according to claim 16, wherein the diamond is monocrystalline.

19. A protective glass for a smart phone, comprising:
a first surface and a second surface spaced apart by a thickness therebetween;
a circumferential edge defining a side surface of the first and second surfaces and the thickness;
wherein the thickness between the first and second surfaces and within the circumferential edge is made from diamond.
